(19) United States
(12) Patent Application Publication
(10) Pub. No.: US 2026/0187245 A1
(43) Pub. Date: Jul. 2, 2026

(54) RANSOMWARE DETECTING AND PREVENTING PROCESS

(71) Applicant: Plume Security, Inc., Atlanta, GA (US)

(72) Inventor: Zachary L. Link, Atlanta, GA (US)

(21) Appl. No.: 19/397,975

(22) Filed: Nov. 23, 2025

Related U.S. Application Data
(60) Provisional application No. 63/739,910, filed on Dec. 30, 2024.

(51) Int. Cl. G06F 21/56; G06F 21/55

(52) U.S. Cl. CPC G06F 21/565; G06F 21/554; G06F 21/568

(57) ABSTRACT

An example operation may include one or more of booting a file system and retrieving a configuration file of the file system, configuring a ransomware detection system based on configuration data within the configuration file of the file system, detecting an operation that is performed by a user to a file stored within the file system, executing a multi-layered ransomware detection on the file utilizing the ransomware detection system and content of the file, and in response to detecting occurrence of ransomware within the file, preventing the ransomware from effecting additional files within the file system

### BACKGROUND

Ransomware is a malicious software that blocks access to data files within a storage system. The ransomware may encrypt files and add extensions to the files and only provide access after a ransom is paid.

### BRIEF DESCRIPTION OF THE DRAWINGS

FIGS. 1A-1C are diagrams illustrating a ransomware detecting and preventing system according to an embodiment of the instant solution.

FIG. 2 is a diagram illustrating a process of consolidating alerts according to an embodiment of the instant solution.

FIG. 3 is a diagram illustrating a computing system for use in any of the example embodiments according to an embodiment of the instant solution.

FIG. 4A is a flow diagram illustrating a method according to examples and features of the instant solution.

FIG. 4B is another flow diagram illustrating a method according to examples and features of the instant solution.

FIG. 5A is a system diagram illustrating integration of an AI model into any decision point according to the examples and features of the instant solution.

FIG. 5B is a diagram illustrating a process for developing an AI model that supports AI-assisted computer decision points according to the examples and features of the instant solution.

FIG. 5C is a diagram illustrating a process for utilizing an AI model that supports AI-assisted computer decision points according to examples and features of the instant solution.

### DETAILED DESCRIPTION

It is to be understood that although this disclosure includes a detailed description of cloud computing, implementation of the teachings recited herein is not limited to a cloud computing environment. Rather, embodiments of the instant solution are capable of being implemented in conjunction with any other type of computing environment now known or later developed.

The example embodiments are directed to a detection system that is capable of detecting the start of a ransomware attack. The system can also take action to prevent the ransomware attack from spreading. As an example, the detection system may perform a multi-layered ransomware detection process in real-time, thereby catching the start of a ransomware attack and enabling the detection system to prevent the spread of the ransomware attack almost immediately.

The system may include an analyzer component that is installed within a customer's monitoring environment where data and files are stored, for example, an on-premises server, a cloud-based storage, a cloud server, file sharing services (Google Drive, Dropbox, etc.), and the like. The system may also include a management component (e.g., an administrative console) that is embodied as a software-as-a-service (SaaS) application hosted on a remote host platform or as on-premises, customer-managed software. The analyzer component may detect any changes that occur to a storage system such as when a new file is created, when a file is read, when a file is updated (e.g., modified, etc.), when a file is deleted, and the like.

In response to detecting a change to a file, the analyzer component may execute a multi-layered ransomware detection process on the contents of the file. When ransomware is detected, the analyzer component may take action to prevent the ransomware attack from spreading including, but not limited to, blocking access to a user account that performed the operation on the file, blocking network access from the attacker, generating one or more alerts, and the like.

Furthermore, when ransomware attacks occur, they often spread quickly to many different files. In some cases, the analyzer component may detect the occurrence of ransomware on multiple files before the ransomware process can be stopped. During this time, many different alerts may be generated by the analyzer component. These alerts can “bombard” an administrator of the system (e.g., hundreds or thousands of alerts per minute, etc.). To prevent this from happening, the analyzer component may execute a consolidation process where the first alert or first few alerts are sent to the administrator console, and the remaining alerts are consolidated and sent in batch to the administrator console. For example, the system may batch alerts over a predetermined interval of time (e.g., 30 seconds, 1 minute, 2 minutes, etc.) and only send a batch of alerts at each predetermined interval of time.

As part of the multi-layered ransomware detection process, the system may utilize machine learning (ML). As one example, a machine learning model may be trained and utilized to identify ransomware notes within a file. For example, the machine learning model may be trained to identify keywords and phrases of a ransomware note (e.g., provide payment, do not contact authorities, use an onion address, act quickly, etc.). Another example would be to identify ransomware-generated file extensions. Files that have been ransomed often have static or machine-generated, random filename extensions that can follow certain patterns that an machine learning algorithm can detect.

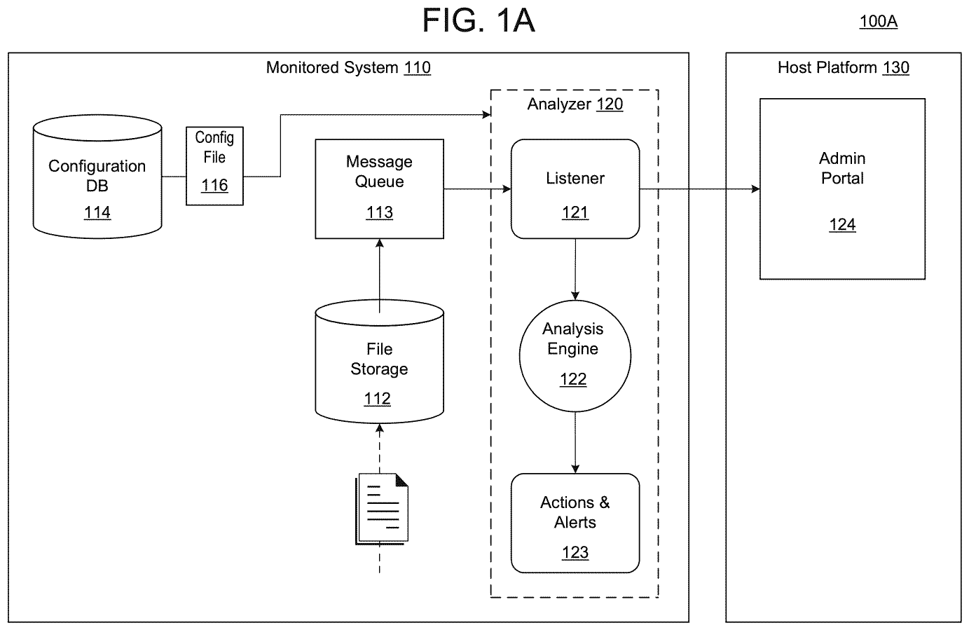

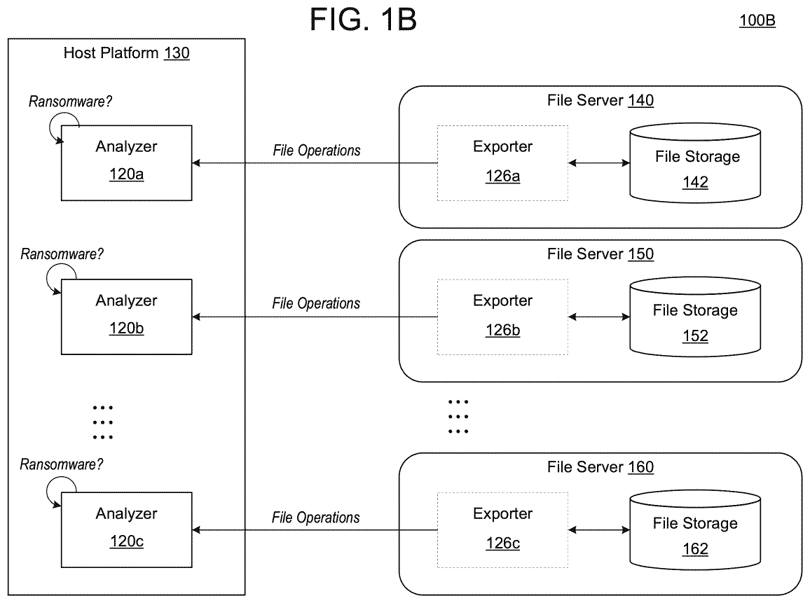

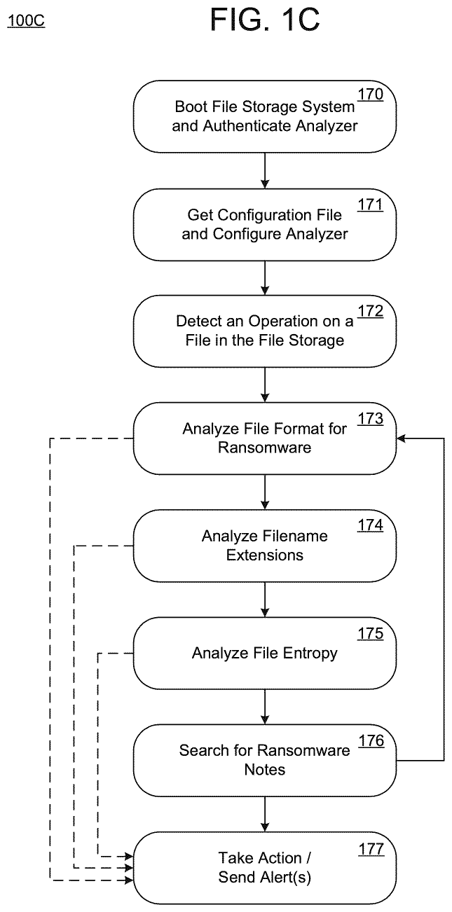

FIGS. 1A-1C illustrate a ransomware stopping detection and stopping system according to an embodiment of the instant solution. For example, FIG. 1A illustrates a process 100A of monitoring a system 110 for ransomware according to examples of the instant solution. Referring to FIG. 1A, an analyzer 120 may be installed on a monitored system 110, for example, a file server that is hosted within an on-premises environment, in a cloud environment, or the like. The monitored system 110 may include a file storage 112 where files are stored and a configuration database 114 where configuration data is stored. The analyzer 120 may be installed in advance of the process 100A being started.

When the monitored system 110 boots, the analyzer 120 may obtain a configuration file 116 of the monitored system 110 from the configuration database 114 and configure the analyzer 120 to monitor the file storage 112. For example, the configuration file 116 may include logging, alerting, and response configurations which the analyzer 120 uses to determine which files to monitor, what to look for, who/what to alert and which automated responses to take in case of a ransomware attack. Once configured, the analyzer 120 begins analyzing operations that are performed on files within the file storage 112 using a multi-layered ransomware detection process that is further described with respect to the examples of FIGS. 1B and 1C.

In the example of FIG. 1A, the analyzer 120 is connected to an administrative portal 124 that is hosted remotely on a host platform 130 such as a web server, cloud platform, etc. which is connected to the monitored system 110 over a network such as the Internet. Here, the analyzer 120 may “authenticate” itself with the administrative portal 124 upon booting. The authentication process may be required before the analyzer 120 is able to start analyzing operations that occur within the file storage 112. The authentication process may include a secure id and password over an encrypted connection (HTTPS) to ensure the security of the analyzer and the administrative portal.

The monitored system 110 also includes a message queue 113 which stores messages that include operations to be performed on files within the file storage 112. Here, the analyzer 120 includes a listener 121 which can listen for operations that are stored within the message queue 113 and identify what operations are being performed to the file storage 112. When the listener 121 detects an operation to a file within the file storage 112, the listener 121 passes the file to an analysis engine 122 which analyzes file metadata and the content within the file for ransomware. For example, the analysis engine 122 may perform a multi-layered ransomware detection process as is further described in the examples below.

When the analysis engine 122 detects ransomware, the analysis engine 122 may trigger an actions and alert module 123 to perform at least one action and/or generate at least one alert. The at least one action may include suspending a compromised user account which performed the operation, killing a process that performed the operation, blocking an IP address of the user at a firewall level, suspending access keys of the user account to the file storage 112, restoring a previous version of the infected file, and the like. As another example, the actions and alert module 123 may generate an alert that may be sent to the administrative portal 124 and/or to any other accounts that are defined, such as an administrator of the monitored system 110.

FIG. 1B illustrates a process 100B in which a remote host platform 130 monitors multiple file servers simultaneously in a distributed system according to examples of the instant solution. Referring to FIG. 1B, rather than host the analyzer on-premises of the customer, in the customer's cloud environment, etc., the analyzer may be hosted by the host platform 130. This enables the host platform 130 to simultaneously monitor multiple servers/file systems at the same time for ransomware via a central host or serverless platform.

For example, a file server 140 may include file storage 142 that is monitored by an analyzer 120a for ransomware. Likewise, a file server 150 may include a file storage 152 that is monitored by an analyzer 120b for ransomware. Furthermore, a file server 160 may include a file storage 162 that is monitored by an analyzer 120c for ransomware. Each instance of the analyzer may be connected to the respective file server through a network, such as the Internet. The analyzer may include a component (e.g., an exporter) that is installed locally on the respective file server and which communicate with the analyzer thereby providing operations that are performed to the respective file storage of the file server.

For example, an exporter 126a may export file operations performed on the file storage 142 to the analyzer 120a. An exporter 126b may export file operations performed on the file storage 152 to the analyzer 120b. Furthermore, an exporter 126c may export file operations performed on the file storage 162 to the analyzer 120c. The exportation process may include exporting files that are created, read, updated, and deleted, thereby enabling the respective analyzer to analyze the content within the files. Here, the analyzers 120a, 120b, and 120c, may analyze the file servers 140, 150, and 160, for ransomware in a distributed environment.

FIG. 1C illustrates a multi-layered ransomware detection process 100C that may be performed by the analyzer according to examples of the instant solution. Referring to FIG. 1C, the system being monitored may be booted in 170. The booting process may also boot an instance of the analyzer that is installed on the system being monitored. In response to being booted, the analyzer may authenticate itself with the administrative console (SaaS application) that is remotely hosted enabling the analyzer to begin analyzing file storage for ransomware. In 171, the analyzer may retrieve a configuration file of the system being monitored, and configure itself to monitor the file storage for ransomware based on configuration settings of the system being monitored.

In 172, the analyzer may detect that an operation has been performed on a file that is stored within the file storage of the system being monitored. The operation may include a creation of a file, a reading of a file, an update to a file, a deletion of a file, and the like. In response to detecting the operation to the file, the analyzer may execute a multi-layered ransomware detection process on the content within the file. The multi-layered ransomware detection process includes steps 173, 174, 175, and 176, which may include file-based detections which may be performed in sequence, in parallel, and the like. The order of the steps may be different than what is shown in FIG. 1C. Furthermore, when one of the steps detects the occurrence of ransomware, the rest of the process may stop, and move to an action taking/alerting process in 177.

For example, in 173, the analyzer may detect for ransomware based on a file format of the file. Most binary file formats have “magic bytes” and other file format structures that correspond with a valid file format. If the file format does not match the file extension, either the file is corrupt or the file has likely been ransomed or otherwise altered for nefarious purposes since it can no longer be used by the designated application. This could indicate hiding data or perhaps encryption like ransomware. This scenario should not occur during normal operations. If file format does not match the file extension, the analyzer may detect the occurrence of ransomware.

In 174, the analyzer may detect for ransomware based on a file extension of the file. Ransomware typically writes files with specific or random extensions that identify those files as being ransomed. The static ones are well known and can be detected immediately by matching the file name extension to a list. For random extensions, they are usually the same for a specific variant of ransomware, meaning in a single ransomware attack on an organization, the files will all have the same random extension. File extensions that are random and consist of 6 or more characters are suspect. The process of multiple unique file extensions, never seen before, can also be a sign of ransomware activity, as well as other signs like an email address included in the file extension. In some embodiments, the analyzer may execute an ML model to determine if the file extension looks look like ransomware. When the analyzer determines the file extension corresponds to a file modified by ransomware, the analyzer may detect the occurrence of ransomware.

In 175, the analyzer may detect for ransomware based on file entropy. Entropy of a file can tell you if it is compressed or encrypted. Algorithms like Shannon-Fano coding and Chi-squared are useful to give a simple number to a whole file. For example, Shannon-Fano coding gives a result of 0-8, with 8 being the most compressed/encrypted. As another example, a Block Frequency/Entropy Histogram can be used to test larger files where ransomware encrypts blocks of data, skips some data, then encrypts more data. Histograms can show a very consistent pattern of high entropy spikes that you would not see with Shannon-Fano coding or Chi-squared entropy. By monitoring entropy of a file over a number of writes, the analyzer may be able to predict when ransomware is executing.

In 176, the analyzer may detect for ransomware based on ransom notes being left within a directory of the file. In some embodiments, the analyzer may use an ML model to analyze the note left in the directory to determine if it is ransomware, for example, based on keywords, key phrases, and the like. Ransom Notes are created during the ransom operation, sometimes before files are encrypted, sometimes afterwords. A ransom note is usually written in every affected directory, so there could be one hundred or more ransom notes in a single attack. Ransom notes are usually text and/or html files that tell the victim how to pay the ransom to get their files decrypted. Analyzing these files for common words or ML models may indicate a ransomware event in progress.

When ransomware is detected by any of the steps 173, 174, 175, and 176, action may be taken to prevent the spread of the ransomware and alerts may be generated in 177. When ransomware is not detected, the process may be repeated each time a new file operation is performed on a file in the file storage.

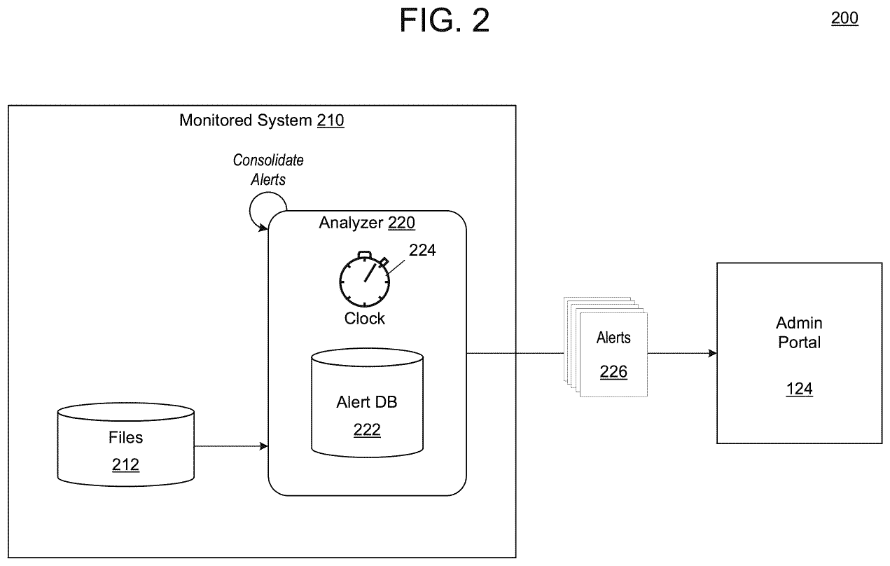

FIG. 2 illustrates a process 200 of consolidating alerts according to an embodiment of the instant solution. As noted, ransomware may infect hundreds of files (or thousands of files) within a very short period of time. Alerts can be in the form of emails, messages displayed on a GUI of the console, sent to security tools such as Security Information and Event management (SIEM) and Security Orchestration, Automation, and Response (SOAR) for further analysis and response, and the like. If an alert were to be generated for each infected file, the alerts could overwhelm the administrator reading the alerts. Referring to FIG. 2, an analyzer 220 may monitor a storage of files 212 on a monitored system 210 for operations. When ransomware is detected, the analyzer 220 may generate alerts and send alerts to the administrative portal 124 on the remote host platform.

Initially, the analyzer 220 may send an alert when a first ransomed file is detected. In some embodiments, the analyzer 220 may send an alert for each of a first predetermined number of ransomed files detected (e.g., two, five, ten, etc.) After the initial alerting process, the analyzer 220 may begin consolidating alerts by storing the alerts within an alerting database 222. The analyzer 220 may also monitor a clock 224 and generate a batch of alerts 226 and send the batch of alerts at predetermined intervals (e.g., every 15 seconds, every 30 seconds, every minute, every two minutes, etc.). The batch of alerts 226 may include a summary which describes the number of total alerts generated over the interval of time, the names of the files that have been ransomed, the names of the directories where the files are located, a user or users that are causing the ransomware to infect the system, and the like.

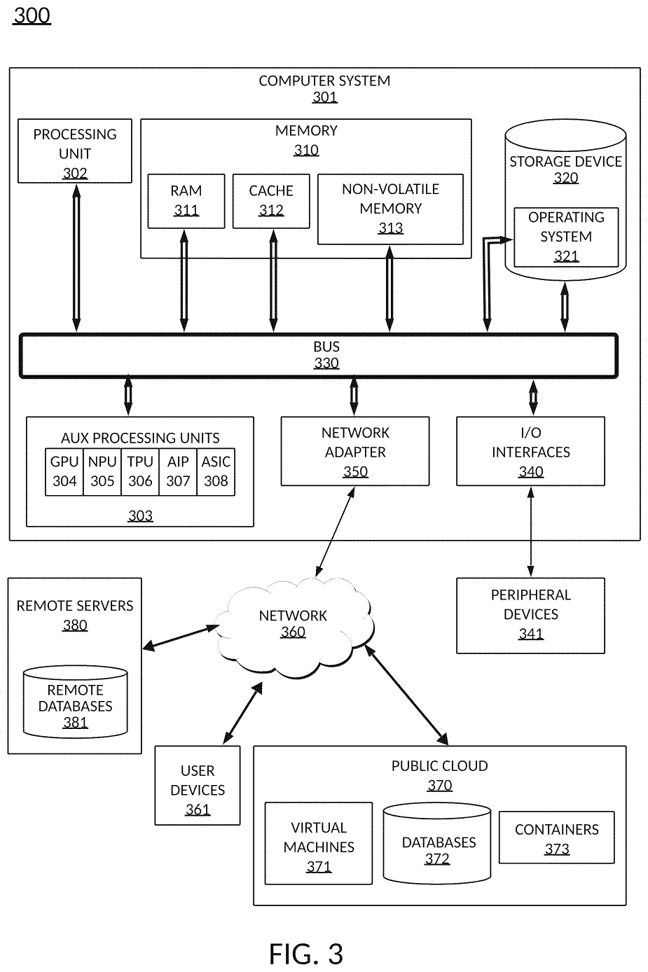

The examples and features of the instant solution may be implemented in at least one of the elements described or depicted herein, including for example, the elements described or depicted in FIG. 3. These examples and features may further be implemented in hardware, in a computer program executed by a processor, in firmware, or in a combination of the above. A computer program may be embodied on a computer readable medium, such as a storage medium. For example, a computer program may reside in random access memory (RAM), flash memory, read-only memory (ROM), erasable programmable read-only memory (EPROM), electrically erasable programmable read-only memory (EEPROM), registers, hard disk, a removable disk, a compact disk read-only memory (CD-ROM), or any other form of storage medium known in the art.

An exemplary storage medium may be communicatively coupled to the processor such that the processor may read information from, and write information to, the storage medium. In the alternative, the storage medium may be integral to the processor. The processor and the storage medium may reside in an application specific integrated circuit (ASIC). In the alternative, the processor and the storage medium may reside as discrete components. For example, FIG. 3 illustrates an example computer system architecture, which may represent or be integrated in any of the above-described components, etc.

FIG. 3 illustrates a computing environment according to the instant solution's example features, structures, or characteristics. FIG. 3 is not intended to suggest any limitation as to the scope of use or functionality of features, structures, or characteristics of the instant solution of the application described herein. Regardless, the computing environment 300 can be implemented to perform any of the functionalities described herein. In computing environment 300, there is a computer system 301, operational within numerous other general-purpose or special-purpose computing system environments or configurations.

Computer system 301 may take the form of a desktop computer, laptop computer, tablet computer, smartphone, smartwatch or other wearable computer, server computer system, thin client, thick client, network computer system, minicomputer system, mainframe computer, quantum computer, and distributed cloud computing environment that include any of the described systems or devices, and the like or any other form of computer or mobile device now known or to be developed in the future that is capable of running a program, accessing a network 360 or querying a database. Depending upon the technology, the performance of a computer-implemented method may be distributed among multiple computers and among multiple locations. However, in this presentation of the computing environment 300, a detailed discussion is focused on a single computer, specifically computer system 301, to keep the presentation as simple as possible.

Computer system 301 may be located in a cloud, even though it is not shown in a cloud in FIG. 3. On the other hand, computer system 301 may not be in a cloud except to any extent as may be affirmatively indicated. Computer system 301 may be described in the general context of computer system-executable instructions, such as program modules, executed by a computer system 301. Generally, program modules may include routines, programs, objects, components, logic, data structures, and so on that perform tasks or implement certain abstract data types. As shown in FIG. 3, computer system 301 in computing environment 300 is shown in the form of a general-purpose computing device. The components of computer system 301 may include but are not limited to, at least one processor or processing unit 302, a system memory 310, and a bus 330 that couples various system components, including system memory 310 to processing unit 302.

Processing unit 302 includes at least one computer processor of any type now known or to be developed. The processing unit 302 may contain circuitry distributed over multiple integrated circuit chips. The processing unit 302 may also implement multiple processor threads and multiple processor cores. Cache 312 is a memory that may be in the processor chip package(s) or located “off-chip,” as depicted in FIG. 3. Cache 312 is typically used for data or code accessed by the threads or cores running on the processing unit 302. In some computing environments, processing unit 302 may be designed to work with qubits and perform quantum computing.

The Auxiliary Processing Units (APU) 303 may contain at least one Graphics Processing Unit (GPU) 304, Neural Processing Unit (NPU) 305, Tensor Processing Unit (TPU) 306, AI Processor (AIP) 307, or other Application Specific Integrated Circuit (ASIC) 308. The at least one APU 303 may contain circuitry distributed over multiple integrated circuit chips. Each APU 303 may implement multiple processor threads and multiple processor cores. Each APU 303 may include at least one of onboard memory, onboard memory cache, and onboard instruction cache. Each APU may be communicatively coupled to the system bus 330 and configure to communicate with other system components, including a processing unit 302, system cache 312, RAM 311, non-volatile RAM 313, operating system 321, Network adapter 350, and Input/Output interfaces 340. In some computing environments, at least one of the at least one APU 303 may be designed to work with qubits and perform quantum computing.

Memory 310 is any volatile memory now known or to be developed in the future. Examples include dynamic random-access memory (RAM) 311 or static type RAM 311. Typically, the volatile memory is characterized by random access, but this may not be the characterization unless affirmatively indicated. In computer system 301, memory 310 is in a single package. It is internal to computer system 301, but alternatively or additionally, the volatile memory may be distributed over multiple packages and/or located externally with respect to computer system 301. By way of example, memory 310 can be provided for reading from and writing to a non-removable, non-volatile magnetic media (shown as storage device 320, and typically called a “hard drive”). Memory 310 may include at least one program product having a set (e.g., at least one) of program modules configured to carry out the functions of various features, structures, or characteristics of the instant solution of the application. A typical computer system 301 may include cache 312, a specialized volatile memory generally faster than RAM 311 and generally located closer to the processing unit 302. Cache 312 stores frequently accessed data and instructions accessed by the processing unit 302 to speed up processing time. The computer system 301 may also include non-volatile memory 313 in the form of ROM, PROM, EEPROM, and flash memory. Non-volatile memory 313 often contains programming instructions for starting the computer, including the basic input/output system (BIOS) and information to start the operating system 321.

Computer system 301 may include a removable/non-removable, volatile/non-volatile computer storage device 320. For example, storage device 320 can be a non-removable, non-volatile magnetic media (not shown and typically called a “hard drive”). At least one data interface can connect it to the bus 330. In features, structures, or characteristics of the instant solution where computer system 301 has a large amount of storage (for example, where computer system 301 locally stores and manages a large database), then this storage may be provided by peripheral storage devices 320 designed for storing very large amounts of data, such as a storage area network (SAN) that is shared by multiple, geographically distributed computers.

The operating system 321 is software that manages computer system 301 hardware resources and provides common services for computer programs. Operating system 321 may take several forms, such as various known proprietary operating systems or open-source Portable Operating System Interface type operating systems that employ a kernel.

The bus 330 represents at least one of several types of bus structures, including a memory bus or memory controller, a peripheral bus, an accelerated graphics port, and a processor or local bus using various bus architectures. By way of example, and not limitation, such architectures include Industry Standard Architecture (ISA) buses, Micro Channel Architecture (MCA) buses, Enhanced ISA (EISA) buses, Video Electronics Standards Association (VESA) local buses, and Peripheral Component Interconnect (PCI) bus. The bus 330 is the signal conduction path that allows the various components of computer system 301 to communicate.

Computer system 301 may communicate with at least one peripheral device, 341, via an input/output (I/O) interface, 340. Such devices may include a keyboard, a pointing device, a display, etc.; at least one device that enables a user to interact with computer system 301; and/or any devices (e.g., network card, modem, etc.) that enable computer system 301 to communicate with at least one other computing devices. Such communication can occur via I/O interface 340. As depicted, I/O interface 340 communicates with the other components of computer system 301 via bus 330.

Network adapter 350 enables the computer system 301 to connect and communicate with at least one network 360, such as a local area network (LAN), a wide area network (WAN), and/or a public network (e.g., the Internet). It bridges the computer's internal bus 330 and the external network, exchanging data efficiently and reliably. The network adapter 350 may include hardware, such as modems or Wi-Fi signal transceivers, and software for packetizing and/or de-packetizing data for communication network transmission. Network adapter 350 supports various communication protocols to ensure compatibility with network standards. Ethernet connections adhere to protocols such as IEEE 802.3, while wireless communications might support IEEE 802.11 standards, Bluetooth, near-field communication (NFC), or other network wireless radio standards.

Network 360 is any computer network that can receive and/or transmit data. Network 360 can include a WAN, LAN, private cloud, or public Internet, capable of communicating computer data over non-local distances by any technology that is now known or to be developed in the future. Any connection depicted can be wired and/or wireless and may traverse other components that are not shown. In some features, structures, or characteristics of the instant solution, a network 360 may be replaced and/or supplemented by LANs designed to communicate data between devices in a local area, such as a Wi-Fi network. The network 360 typically includes computer hardware such as copper transmission cables, optical transmission fibers, wireless transmission, routers, firewalls, switches, gateway computers, edge servers, and network infrastructure known now or to be developed in the future. Computer system 301 connects to network 360 via network adapter 350 and bus 330.

User devices 361 are any computer systems used and controlled by an end user in connection with computer system 301. For example, in a hypothetical case where computer system 301 is designed to provide a recommendation to an end user, this recommendation may typically be communicated from network adapter 350 of computer system 301 through network 360 to a user device 361, allowing user device 361 to display, or otherwise present, the recommendation to an end user. User devices can be a wide array, including personal computers, laptops, tablets, hand-held, mobile phones, etc.

A public cloud 370 is an on-demand availability of computer system resources, including data storage and computing power, without direct active management by the user. Public clouds 370 are often distributed, with data centers in multiple locations for availability and performance. Computing resources on public clouds 370 are shared across multiple tenants through virtual computing environments comprising virtual machines 371, databases 372, containers 373, and other resources. A container 373 is an isolated, lightweight software for running a software application on the host operating system 321. Containers 373 are built on top of the host operating system's kernel and contain software applications and some lightweight operating system APIs and services. In contrast, virtual machine 371 is a software layer with an operating system 321 and kernel. Virtual machines 371 are built on top of a hypervisor emulation layer designed to abstract a host computer's hardware from the operating software environment. Public clouds 370 generally offers databases 372, abstracting high-level database management activities. At least one element described or depicted in FIG. 3 can perform at least one of the actions, functionalities, or features described or depicted herein.

Remote servers 380 are any computers that serve at least some data and/or functionality over a network 360, for example, WAN, a virtual private network (VPN), a private cloud, or via the Internet to computer system 301. These networks 360 may communicate with a LAN to reach users. The user interface may include a web browser or a software application that facilitates communication between the user and remote data. Such software applications have been referred to as “thin” desktop software applications or “thin clients.” Thin clients typically incorporate software programs to emulate desktop sessions. Mobile device software applications can also be used. Remote servers 380 can also host remote databases 381, with the database located on one remote server 380 or distributed across multiple remote servers 380. Remote databases 381 are accessible from database client applications installed locally on the remote server 380, other remote servers 380, user devices 361, or computer system 301 across a network 360. An AI/ML model described or depicted here may reside fully or partially on any of the elements described or depicted in FIG. 3.

Although an exemplary example of the instant solution of at least one of an apparatus, method, and computer readable medium has been illustrated in the accompanying drawings and described in the foregoing detailed description, it will be understood that the instant solution is not limited to the examples of the instant solution disclosed but is capable of numerous rearrangements, modifications, and substitutions as set forth and defined by the following claims. For example, the instant solution's capabilities of the various figures can be performed by at least one of the modules or components described herein or in a distributed architecture and may include a transmitter, receiver, or pair of both. For example, all or part of the functionality performed by the individual modules may be performed by at least one of these modules. Further, the functionality described herein may be performed at various times and in relation to various events, internal or external to the modules or components. Also, the information sent between various modules can be sent between the modules via at least one of a data network, the Internet, a voice network, an Internet Protocol network, a wireless device, a wired device and/or via a plurality of protocols. Also, the messages sent or received by any of the modules may be sent or received directly and/or via at least one of the other modules.

One skilled in the art will appreciate that the instant solution may be embodied as a personal computer, a server, a console, a personal digital assistant (PDA), a cell phone, a tablet computing device, a smartphone, or any other suitable computing device, or combination of devices. Presenting the above-described functions as being performed by the instant solution is not intended to limit the scope of the present instant solution in any way but is intended to provide one example of the many examples of the instant solution. Indeed, methods, systems, and apparatuses disclosed herein may be implemented in localized and distributed forms consistent with computing technology.

It should be noted that some of the instant solution features described in this specification have been presented as modules in order to more particularly emphasize their implementation independence. For example, a module may be implemented as a hardware circuit comprising custom very large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise at least one physical or logical block of computer instructions that may, for instance, be organized as an object, procedure, or function. Nevertheless, the executables of an identified module may not be physically located together but may comprise disparate instructions stored in different locations which, when joined logically together, comprise the module and achieve the stated purpose for the module. Further, modules may be stored on a computer-readable medium, which may be, for instance, a hard disk drive, flash device, random access memory, tape, or any other such medium used to store data.

Indeed, a module of executable code may be a single instruction or many instructions and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations, including over different storage devices, and may exist, at least partially, merely as electronic signals on a system or network.

It will be readily understood that the components of the instant solution, as generally described and illustrated in the figures herein, may be arranged and designed in a wide variety of different configurations. Thus, the detailed descriptions of the instant solution and the examples and features of the instant solution are not intended to limit the scope of the instant solution as claimed but are merely representative examples of the instant solution.

One having ordinary skill in the art will readily understand that the above may be practiced with steps in a different order and/or with hardware elements in configurations that are different from those which are disclosed. Therefore, although the instant solution has been described based upon these preferred examples and features of the instant solution, it would be apparent to those of skill in the art that certain modifications, variations, and alternative constructions would be apparent.

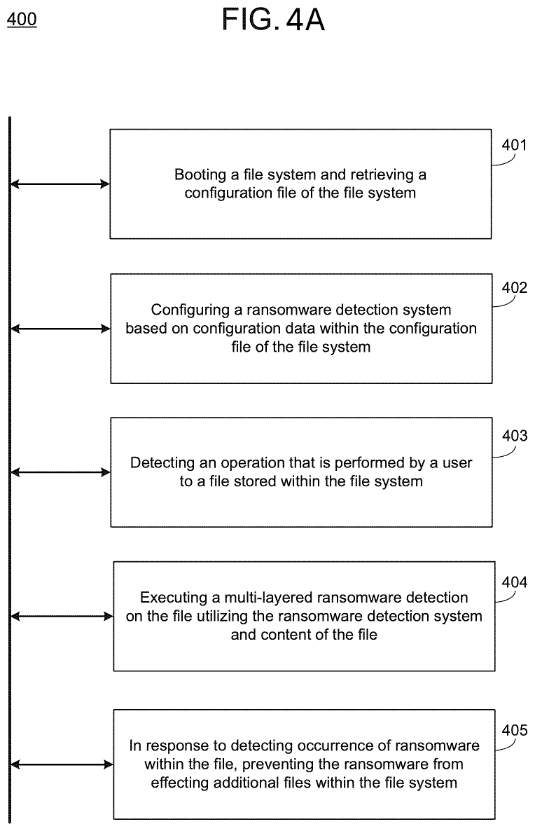

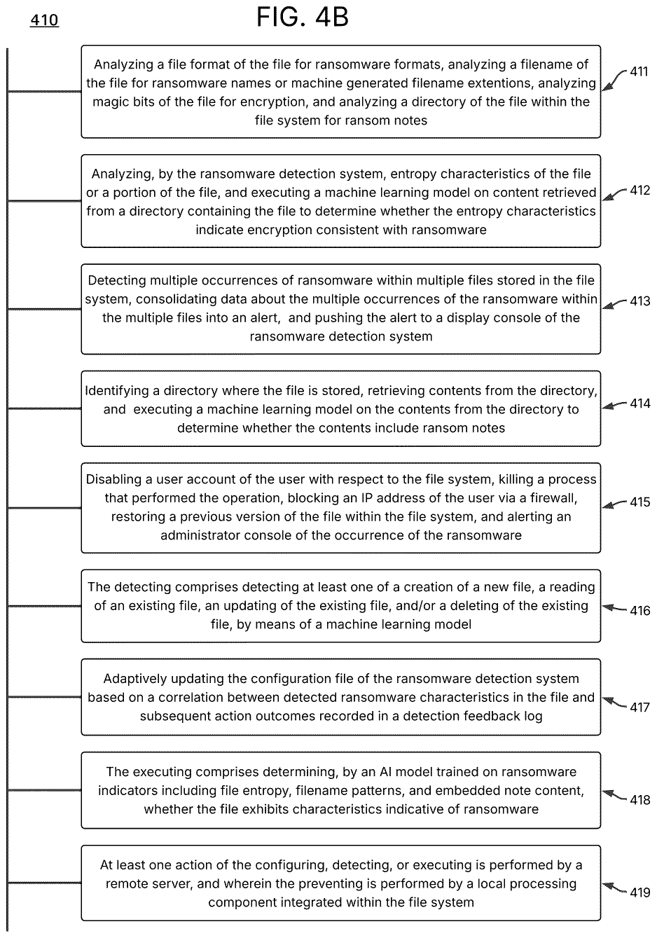

FIG. 4A illustrates a flow diagram of a method 400, according to example embodiments. Referring to FIG. 4A, in 401, the method may include booting a file system and retrieving a configuration file of the file system. In 402, the method may include configuring a ransomware detection system based on configuration data within the configuration file of the file system In 403, the method may include detecting an operation that is performed by a user to a file stored within the file system. In 404, the method may include executing a multi-layered ransomware detection on the file utilizing the ransomware detection system and content of the file. In 405, in response to detecting occurrence of ransomware within the file, the method may include preventing the ransomware from effecting additional files within the file system.

In some embodiments, the executing may include analyzing a file format of the file for ransomware formats, analyzing a filename of the file for ransomware names, analyzing magic bits of the file for encryption, and analyzing a directory of the file within the file system for ransom notes. In some embodiments, the method may further include detecting multiple occurrences of ransomware within multiple files stored in the file system, consolidating data about the multiple occurrences of the ransomware within the multiple files into a single alert, and pushing the alert to a display console of the ransomware detection system.

In some embodiments, the method may further include identifying a directory where the file is stored, retrieving contents from the directory, and executing a machine learning model on the contents from the directory to determine whether the contents include ransom notes. In some embodiments, the preventing may include disabling a user account of the user with respect to the file system, killing a process that performed the operation, blocking an IP address of the user via a firewall, restoring a previous version of the file within the file system, and alerting an administrator console of the occurrence of the ransomware. In some embodiments, the detecting may include detecting at least one of a creation of a new file, a reading of an existing file, an updating of the existing file, and a deleting of the existing file.

Detailed descriptions of training a machine learning model and executing a machine learning model are further described and depicted herein.

FIG. 4B illustrates a flow diagram of a method 410, according to example embodiments. Referring to FIG. 4B, in 411, the method may include analyzing a file format of the file for ransomware formats, analyzing a filename of the file for ransomware names or machine generated filename extensions, analyzing magic bits of the file for encryption, and analyzing a directory of the file within the file system for ransom notes. In 412, the method may include analyzing, by the ransomware detection system, entropy characteristics of the file or a portion of the file, and executing a machine learning model on content retrieved from a directory containing the file to determine whether the entropy characteristics indicate encryption consistent with ransomware. In 413, the method may include detecting multiple occurrences of ransomware within multiple files stored in the file system, consolidating data about the multiple occurrences of the ransomware within the multiple files into an alert, and pushing the alert to a display console of the ransomware detection system. In 414, the method may include identifying a directory where the file is stored, retrieving contents from the directory, and executing a machine learning model on the contents from the directory to determine whether the contents include ransom notes. In 415, the method may include disabling a user account of the user with respect to the file system, killing a process that performed the operation, blocking an IP address of the user via a firewall, restoring a previous version of the file within the file system, and alerting an administrator console of the occurrence of the ransomware. In 416, the method may include the detecting comprising detecting at least one of a creation of a new file, a reading of an existing file, an updating of the existing file, and/or a deleting of the existing file, by means of a machine learning model. In 417, the method may include adaptively updating the configuration file of the ransomware detection system based on a correlation between detected ransomware characteristics in the file and subsequent action outcomes recorded in a detection feedback log. In 418, the method may include the executing comprising determining, by an AI model trained on ransomware indicators including file entropy, filename patterns, and embedded note content, whether the file exhibits characteristics indicative of ransomware. In 419, the method may include at least one action of the configuring, detecting, or executing is performed by a remote server, and wherein the preventing is performed by a local processing component integrated within the file system.

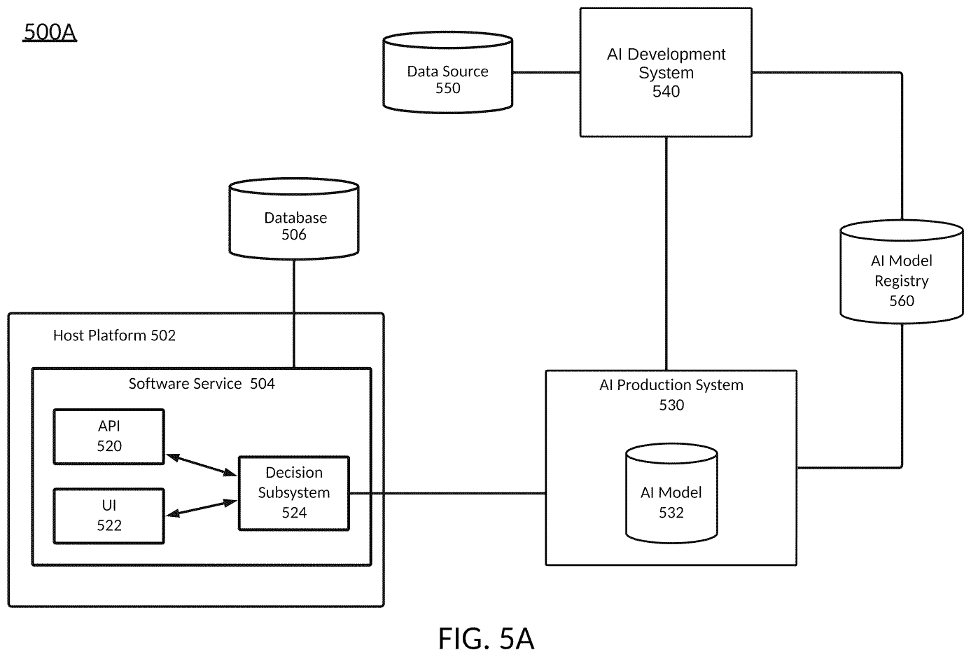

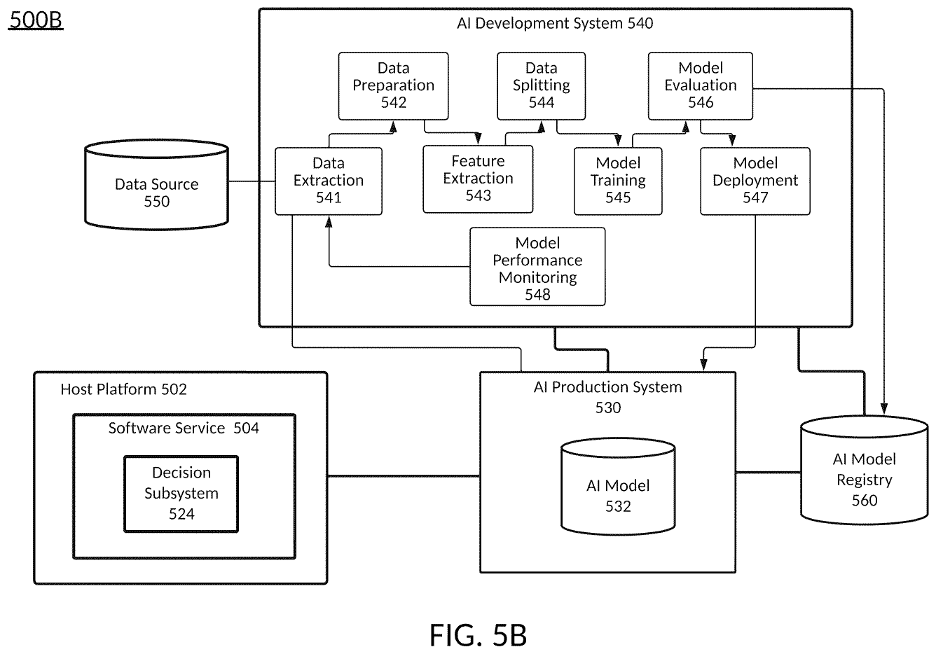

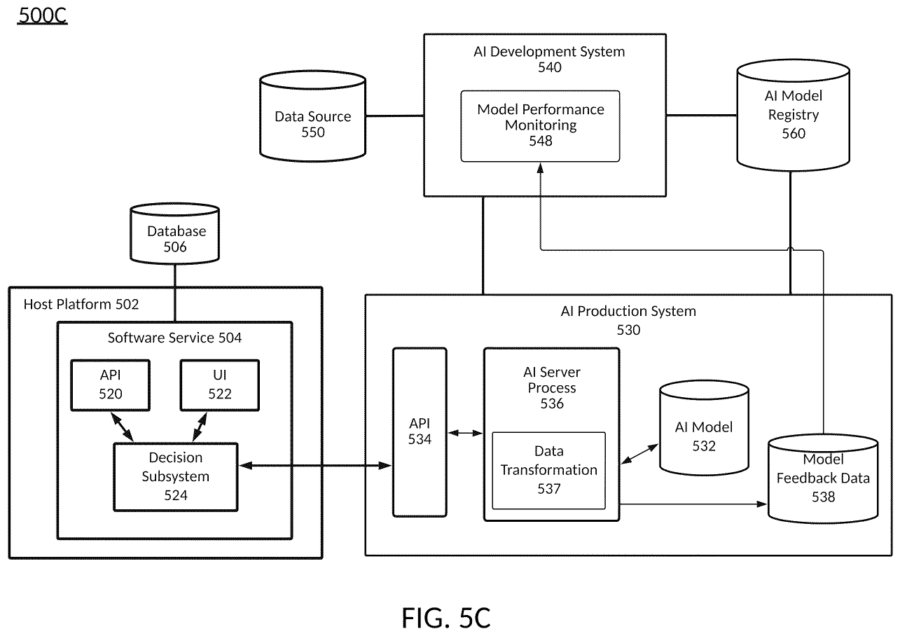

FIG. 5A illustrates an artificial intelligence (AI) network diagram 500A that supports AI-assisted decision points in a software service executing on a computer. As one example, the AI model being trained in the examples herein may refer to an AI model for any of the tasks performed herein including a machine learning model, a neural network, a large language model (LLM), and the like. While the example instant solution shown utilizes a neural network, which is a type of machine learning (ML) model, other branches of AI, such as, but not limited to, computer vision, fuzzy logic, expert systems, deep learning, generative AI, and natural language processing, may be employed in developing the AI model in this instant solution. Further, the AI model included in these examples and features of the instant solution is not limited to particular AI algorithms. Any algorithm or combination of algorithms related to supervised, unsupervised, and reinforcement learning may be employed.

The AI models, ML models, neural networks, and other branches of AI, described and/or depicted herein, build upon the fundamentals of predecessor technologies and form the foundation for all future technological advancements in artificial intelligence. An AI classification system describes the stages of AI progression and advancement. The first classification is known as “reactive machines,” followed by present-day AI classification “limited memory machines” (also known as “artificial narrow intelligence”), then progressing to “theory of mind” (also known as “artificial general intelligence”) and reaching the AI classification “self-aware” (also known as “artificial superintelligence”). Present-day limited memory machines are a growing group of AI models built upon the foundation of their predecessors, reactive machines. Reactive machines emulate human responses to stimuli; however, they are limited in their capabilities as they cannot typically learn from prior experience. Once the AI model's learning abilities emerged, its classification was promoted to limited memory machines. In this present-day classification, AI models learn from large volumes of data, detect patterns, solve problems, generate, and predict data, and the like, while inheriting all the capabilities of reactive machines.

Examples of AI models classified as limited memory machines include, but are not limited to, chatbots, virtual assistants, machine learning, neural networks, deep learning, natural language processing, generative AI models, and any future AI models that are yet to be developed possessing characteristics of limited memory machines.

For example, a neural network is a type of machine learning model that relies on training data to learn associations and connections, improving its accuracy for performing high speed data classifications, clustering, and other analyses of data. Such neural network capabilities are the foundation of deep learning models today as well as becoming the foundational blocks of those yet to be developed.

For example, generative AI models combine limited memory machine technologies, incorporating machine learning and deep learning, forming the foundational building blocks of future AI models. For example, theory of mind is the next progression of AI that may be able to perceive, connect, and react by generating appropriate reactions in response to an entity with which the AI model is interacting; all these theory of mind capabilities relies on the fundamentals of generative AI. Furthermore, in an evolution into the self-aware classification, AI models will be able to understand and evoke emotions in the entities they interact with, as well as possessing their own emotions, beliefs, and needs, all of which rely on generative AI fundamentals of learning from experiences to generate and draw conclusions about itself and its surroundings.

AI models may include, but are not limited to, at least one machine learning model, neural network model, deep learning model, generative AI model, or any combination of models from the branches of AI. AI models are integral and core to future artificial intelligence models. As described herein, AI model refers to present-day AI models and future AI models.

Artificial intelligence systems have been built and trained to perform various tasks in an automated manner. For example, artificial intelligence systems receive and understand verbal and/or written dialogue and function as digital assistants, speech-to-text programs, etc. Other artificial intelligence systems are trained on different types of information to allow the trained system to generate content - such as new works of art based on the styles seen, or new compound ideas based on the history of chemical research.

Foundation models are types of artificial intelligence systems that are trained on a broad set of unlabeled data that can be used for different tasks, with minimal fine-tuning. The unlabeled data includes in some instances imagery and/or language. In response to a short prompt being input into the foundation model, the system generates an output such as an entire essay, or a complex image, based on the parameters that are set forth in the input prompt. The foundation model is able to produce an output that attempts to meet the parameters even if the foundation model was never trained with specific training data that included the exact parameters, e.g., was never trained for that exact argument or to generate an image in that way.

Using self-supervised learning and transfer learning, foundation models can apply information that they have learnt about one situation to another. For example, like a human learns how to drive on one car, for example, and without too much effort, could learn how to drive other types of vehicles such as other cars, a truck, or a bus. The foundation model similarly is used to achieve proficiency in some new area without having to be trained completely from scratch. Foundation models seem to have inherent creativity in performing tasks such as stringing together coherent arguments or creating entirely original pieces of art. Foundation models are established in the technology of natural-language processing. One example of how foundation models are helpful is that for previous generation of AI techniques, if you wanted to build an AI model that could summarize bodies of text for you, you would need tens of thousands of labeled examples just for the summarization use case. With a pre-trained foundation model, the labeled data requirements are dramatically reduced. First, the foundation model is fine-tuned with a domain-specific unlabeled corpus to create a domain-specific foundation model. Then, using a much smaller amount of labeled data, potentially just a thousand labeled examples, a foundation model is trained for summarization. The domain-specific foundation model can be used for many tasks as opposed to the previous technologies that required building models from scratch in each use case. Foundation models are even applicable in areas such as computer programming coding analysis, generation, and repair.

Some foundation models are used for sentiment analysis. With pre-trained foundation models, sentiment analysis on a new language can be trained using as little as a few thousand sentences—100 times fewer annotations required than previous models. Reducing labeling requirements will make it much easier for implementation in various technical areas. Systems that execute specific tasks in a single domain are giving way to broad AI that learns more generally and works across domains and problems. Foundation models, trained on large, unlabeled datasets and fine-tuned for an array of applications, are driving this shift.

Large language models (LLMs) are a category of foundation models trained on immense amounts of data making them capable of understanding and generating natural language and other types of content to perform a wide range of tasks. LLMs have been implemented at different levels to enhance their natural language understanding (NLU) and natural language processing (NLP) capabilities. This advancement of LLMs has occurred alongside advances in machine learning, machine learning models, algorithms, neural networks and the transformer models that provide the architecture for these AI systems.

LLMs are a class of foundation models, which are trained on enormous amounts of data to provide the foundational capabilities needed to drive multiple use cases and applications, as well as resolve a multitude of tasks. This LLM concept is in stark contrast to the idea of building and training domain specific models for each of these use cases individually, which is prohibitive under many criteria (most importantly cost and infrastructure), stifles synergies and can even lead to inferior performance.

LLMs represent a significant breakthrough in NLP and artificial intelligence. LLMs are accessible through interfaces like Open AI's Chat GPT-3 and GPT-4, which have garnered the support of Microsoft. Other examples include Meta's Llama models and Google's bidirectional encoder representations from transformers (BERT/RoBERTa) and PaLM models. IBM has also recently launched its Granite model series on watsonx.ai, which has become the generative AI backbone for other IBM products like watsonx Assistant and watsonx Orchestrate.

In a nutshell, LLMs are designed to understand and generate text like a human, in addition to other forms of content, based on the vast amount of data used to train them. They have the ability to infer from context, generate coherent and contextually relevant responses, translate to languages other than English, summarize text, answer questions (general conversation and FAQs) and even assist in creative writing or code generation tasks. LLMs are able to do some or all of these tasks thanks to many, e.g., billions of, parameters that enable them to capture intricate patterns in language and perform a wide array of language-related tasks. LLMs are revolutionizing applications in various fields, from chatbots and virtual assistants to content generation, research assistance and language translation.

LLMs operate by leveraging deep learning techniques and vast amounts of textual data. These models are typically based on a transformer architecture, like the generative pre-trained transformer, which excels at handling sequential data like text input. LLMs consist of multiple layers of neural networks, each with parameters that can be fine-tuned during training, which are enhanced further by a numerous layer known as the attention mechanism, which dials in on specific parts of data sets.

During the training process, these models learn to predict the next word in a sentence based on the context provided by the preceding words. The model does this through attributing a probability score to the recurrence of words that have been tokenized—broken down into smaller sequences of characters. These tokens are then transformed into embeddings, which are numeric representations of this context.

To ensure accuracy, this process involves training the LLM on a large corpus of text (e.g., in the billions of pages), allowing the LLM to learn grammar, semantics and conceptual relationships through zero-shot and self-supervised learning. Once trained on this training data, LLMs can generate text by autonomously predicting the next word based on the input they receive, and drawing on the patterns and knowledge they have acquired. The result is coherent and contextually relevant language generation that can be harnessed for a wide range of NLU and content generation tasks.

Model performance can also be increased through prompt engineering, prompt-tuning, fine-tuning and other tactics like reinforcement learning with human feedback (RLHF) to remove the biases, hateful speech and factually incorrect answers known as “hallucinations” that are often unwanted byproducts of training on so much unstructured data. LLMs augment conversational AI in chatbots and virtual assistants to enhance the interactions that provide context-aware responses that mimic interactions with human agents.

LLMs also excel in content generation, automating content creation for blog articles, explanatory materials, and other writing tasks. LLMs aid in summarizing and extracting information from vast datasets, accelerating knowledge discovery. LLMs also play a vital role in language translation, breaking down language barriers by providing accurate and contextually relevant translations. LLMs can even be used to write code, or “translate” between programming languages. LLMs contribute to accessibility by assisting individuals with disabilities, including text-to-speech applications and generating content in accessible formats.

LLMs often include abilities such as:
Text generation: language generation abilities, such as writing emails, blog posts or other mid-to-long form content in response to prompts that can be refined and polished. An excellent example is retrieval-augmented generation (RAG).
Content summarization: summarize long articles, news stories, research reports, corporate documentation and even interaction history into thorough texts tailored in length to the output format.
AI assistants: chatbots that answer queries, perform backend tasks and provide detailed information in natural language as a part of an integrated, self-serve solution for handling inquiries.
Code generation: assists developers in building applications, finding errors in code and uncovering security issues in multiple programming languages, even “translating” between them.
Sentiment analysis: analyze text to determine a user's tone in order to understand user feedback at scale and aid in brand reputation management.
Language translation: provides wider coverage to organizations across languages and geographies with fluent translations and multilingual capabilities.

Software service 504 (see FIG. 5A), executing on host platform 502 (see FIG. 5A) may provide one or more application programming interfaces (APIs) 520 that enable interaction with other software components via a set of data definitions and protocols. In some examples and features of the instant solution, the APIs provided may employ Simple Object Access Protocol (SOAP), Remote Procedure Calls (RPC), and Representational State Transfer (REST) techniques. In some examples and features of the instant solution, the plurality of APIs 520 send data to one or more decision subsystems 524 of the software service 504 to assist in decision-making. In some examples and features of the instant solution, the software service 504 stores data included in API requests or data generated during processing the API requests into one or more databases 506 (see FIG. 5A).

Software service 504 may provide one or more user interfaces (UIs) 522, such as a server-side hosted graphical user interface (GUI). In some examples and features of the instant solution, the UIs 522 provided employ template-based frameworks, component-based frameworks, etc. In some examples and features of the instant solution, these UIs 522 send data to one or more decision subsystems 524 of the software service 504 to assist with decision-making. In some examples and features of the instant solution, the software service 504 stores data included in UI requests or data generated during processing the UI requests into one or more databases 506.

Software service 504 may include one or more decision subsystems 524 that drive a decision-making process of the software service 504. In some examples and features of the instant solution, the decision subsystems 524 receive data from one or more APIs 520 as input into the decision-making process. In some examples and features of the instant solution, a decision subsystem 524 may receive data from one or more UIs 522 as input to the decision-making process. A decision subsystem 524 may gather service configuration or historical execution data from one or more databases 506 to aid in the decision-making process. A decision subsystem 524 may provide feedback to an API 520 or a UI 522.

An AI production system 530 may be used by a decision subsystem 524 in a software service 504 to assist in its decision-making process. The AI production system 530 includes one or more AI models 532 that are executed to generate a response, such as, but not limited to, a prediction, a categorization, a UI prompt, etc. In some examples and features of the instant solution, an AI production system 530 is hosted on a server. In some examples and features of the instant solution, the AI production system 530 is cloud-hosted. In some examples and features of the instant solution, the AI production system 530 is deployed in a distributed multi-node architecture.

An AI development system 540 creates one or more AI models 532. In some examples and features of the instant solution, the AI development system 540 utilizes data from one or more data sources 550 to develop and train one or more AI models 532. The data sources 550 may be local or third-party data sources. Further, the data provided by the data sources may be real-world or synthetic. In some examples and features of the instant solution, the AI development system 540 utilizes feedback data from one or more AI production systems 530 for new model development and/or existing model re-training. In some examples and features of the instant solution, the AI development system 540 resides and executes on a server. In some examples and features of the instant solution, the AI development system 540 is cloud hosted. In some examples and features of the instant solution, the AI development system 540 is deployed in a distributed multi-node architecture. In some examples and features of the instant solution, the AI development system 540 utilizes a distributed data pipeline/analytics engine.

Once an AI model 532 has been trained and validated in the AI development system 540, it may be stored in an AI model registry 560 for retrieval by either the AI development system 540 or by one or more AI production systems 530. The AI model registry 560 resides in a dedicated server in one example of the instant solution. In some examples and features of the instant solution, the AI model registry 560 is cloud-hosted. In some examples and features of the instant solution, the AI model registry 560 resides in the AI production system 530. In some examples and features of the instant solution, the AI model registry 560 is a distributed database.

FIG. 5B illustrates a process 500B for developing one or more AI models that support AI-assisted decision points. An AI development system 540 executes steps to develop an AI model 532 that begins with data extraction 541, in which data is loaded and ingested from one or more data sources 550. In some examples and features of the instant solution, historical model feedback data is extracted from one or more AI production systems 530.

Once the data has been extracted during data extraction 541, it undergoes data preparation 542 for model training. In some examples and features of the instant solution, this step involves statistical testing of the data to see how well it reflects real-world events, its distribution, the variety of data in the dataset, etc., and the results of this statistical testing may lead to one or more data transformations being employed to normalize one or more values in the dataset. In some examples and features of the instant solution, data deemed to be noisy is cleaned. A noisy dataset includes values that do not contribute to the training, such as, but not limited to, null and long string values. Data preparation 542 may be a manual process or an automated process using one or more of the elements and/or functions described and/or depicted herein.

Features of the data are identified and extracted during the feature extraction step 543. In some examples and features of the instant solution, a feature of the data is internal to the prepared data from the data preparation step 542. In some examples and features of the instant solution, a feature of the data requires a piece of prepared data from the data preparation step 542 to be enriched by data from another data source to be useful in developing the AI model 532. In some examples and features of the instant solution, identifying relevant features (relevant attributes) for model training are performed via an automated process using one or more of the elements and/or functions described and/or depicted herein. Once the features have been identified, the values of the features are collected into a dataset that will be used to develop the AI model 532.

The dataset output from the feature extraction step 543 is split 544 into a training and validation data set. The training data set is used to train the AI model 532, and the validation data set is used to evaluate the performance of the AI model 532 on unseen data.

The AI model 532 is trained and tuned 545 using the training data set from the data splitting step 544. In this step, the training data set is provided to an AI algorithm and an initial set of algorithm parameters which may be automatically determined based on the interdependence between the relevant attributes determined according to various embodiments. The performance of the AI model 532 is then tested within the AI development system 540 utilizing the validation data set from step 544. These steps may be repeated with adjustments to one or more algorithm parameters until the model's performance is acceptable based on various goals and/or results.

The AI model 532 is evaluated 546 in a staging environment (not shown) that resembles the target AI production system 530. This evaluation uses a validation dataset to ensure the performance in an AI production system 530 matches or exceeds expectations. In some examples and features of the instant solution, the validation dataset from step 544 is used. In some examples and features of the instant solution, one or more unseen validation datasets are used. In some examples and features of the instant solution, the staging environment is part of the AI development system 540, and the staging environment is managed separately from the AI development system 540. Once the AI model 532 has been validated, it is stored in an AI model registry 560, where it can be retrieved for deployment and future updates. In some examples and features of the instant solution, the model evaluation step 546 may be a manual process or an automated process using one or more of the elements and/or functions described and/or depicted herein.

In some examples and features of the instant solution, the AI development system includes a user interface (not shown). The user interface may be used to manage the development system infrastructure, the steps 541-548 within the development system, the interim data transmitted between the various steps 541-548, and the data sources 550.

Once an AI model 532 has been validated and published to an AI model registry 560, it may be deployed during the model deployment step 547 to one or more AI production systems 530. In some examples and features of the instant solution, the performance of deployed AI model 532 is monitored 548 by the AI development system 540. In some examples and features of the instant solution, AI model 532 feedback data is provided by the AI production system 530 to enable model performance monitoring 548, and the AI development system 540 periodically requests feedback data for model performance monitoring 548, which includes one or more triggers that result in the AI model 532 being updated by repeating steps 541-548 with updated data from one or more data sources 550.

FIG. 5C illustrates a process 500C for utilizing an AI model that supports AI-assisted decision points. As stated previously, the AI model utilization process depicted herein reflects ML, which is a particular branch of AI, but this instant solution is not limited to ML and is not limited to any AI algorithm or combination of algorithms.

Referring to FIG. 5C, an AI production system 530 may be used by a decision subsystem 524 in software service 504 to assist in its decision-making process. The AI production system 530 provides an API 534, executed by an AI server process 536 through which requests can be made. In some examples and features of the instant solution, a request may include an AI model 532 identifier to be executed based on the type of request. In some examples and features of the instant solution, a data payload (e.g., to be input to the AI model during execution) is included in the request. The data payload may include API 520 data from software service 504, UI 522 data from software service 504 or data from other software service 504 subsystems (not shown).

Upon receiving the API 534 request, the AI server process 536 may transform 537 the data payload or portions of the data payload to be valid feature values in an AI model 532. Data transformation 537 may include, but is not limited to, combining data values, normalizing data values, and enriching the incoming data with data from other data sources 550. Once the data transformation occurs, the AI server process 536 executes the appropriate AI model 532 using the transformed input data. Upon receiving the execution result, the AI server process 536 responds to the API requester, which is a decision subsystem 524 of software service 504. In some examples and features of the instant solution, the response may result in an update to a UI 522 in software service 504. In some examples and features of the instant solution, the response includes a request identifier that can be used later by the software service 504 to provide feedback on the performance of the AI model 532. In some examples and features of the instant solution, a model feedback record may be added into a model feedback data 538 by the AI server process 536.

In some examples and features of the instant solution, the API 534 includes an interface to provide AI model 532 feedback after an AI model 532 execution response has been processed. This mechanism enables the requester to provide feedback on the accuracy of the AI model 532 results. In some examples and features of the instant solution, the feedback interface includes the identifier of the initial request so that it can be used to associate the feedback with the request. Upon receiving a call into the feedback interface of the API 534, the AI server process 536 creates and adds a model feedback record into the model feedback data 538 which holds historical model feedback records. In some examples and features of the instant solution, the records in this model feedback data 538 are provided to model performance monitoring 548 in the AI development system 540. This model feedback data is streamed to the AI development system 540 or may be provided upon request. In some examples and features of the instant solution, the model feedback records in the model feedback data 538 are used as an input for retraining the AI model 532.

In some examples and features of the instant solution, the AI production system 530 includes a user interface (not shown). The user interface may be used to manage the production system infrastructure, the components of the production system 530-538, and the operation of the AI production system and its components.

The above embodiments may be implemented in hardware, in a computer program executed by a processor, in firmware, or in a combination of the above. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

An exemplary storage medium may be coupled to the processor such that the processor may read information from, and write information to, the storage medium. In the alternative, the storage medium may be integral to the processor. The processor and the storage medium may reside in an application-specific integrated circuit (“ASIC”). In the alternative, the processor and the storage medium may reside as discrete components.

What is claimed is:

1. A method comprising:
booting a file system and retrieving a configuration file of the file system;
configuring a ransomware detection system based on configuration data within the configuration file of the file system;
detecting an operation that is performed by a user to a file stored within the file system;
executing a multi-layered ransomware detection on the file utilizing the ransomware detection system and content of the file; and
in response to detecting occurrence of ransomware within the file, preventing the ransomware from effecting additional files within the file system.

2. The method of claim 1, wherein the executing comprises:
analyzing a file format of the file for ransomware formats;
analyzing a filename of the file for ransomware names or machine generated filename extensions;
analyzing magic bits of the file for encryption; and
analyzing a directory of the file within the file system for ransom notes.

3. The method of claim 1, comprising:
analyzing, by the ransomware detection system, entropy characteristics of the file or a portion of the file; and
executing a machine learning model on content retrieved from a directory containing the file to determine whether the entropy characteristics indicate encryption consistent with ransomware.

4. The method of claim 1, comprising:
detecting multiple occurrences of ransomware within multiple files stored in the file system;
consolidating data about the multiple occurrences of the ransomware within the multiple files into an alert; and
pushing the alert to a display console of the ransomware detection system.

5. The method of claim 1, comprising:
identifying a directory where the file is stored;
retrieving contents from the directory; and
executing a machine learning model on the contents from the directory to determine whether the contents include ransom notes.

6. The method of claim 1, wherein the preventing comprises:
disabling a user account of the user with respect to the file system;
killing a process that performed the operation;
blocking an IP address of the user via a firewall;
restoring a previous version of the file within the file system; and
alerting an administrator console of the occurrence of the ransomware.

7. The method of claim 1, wherein the detecting comprises detecting at least one of a creation of a new file, a reading of an existing file, an updating of the existing file, and/or a deleting of the existing file, by means of a machine learning model.

8. The method of claim 1, comprising adaptively updating the configuration file of the ransomware detection system based on a correlation between detected ransomware characteristics in the file and subsequent action outcomes recorded in a detection feedback log.

9. The method of claim 1, wherein the executing comprises determining, by an AI model trained on ransomware indicators including file entropy, filename patterns, and embedded note content, whether the file exhibits characteristics indicative of ransomware.

10. The method of claim 1, wherein at least one action of the configuring, detecting, or executing is performed by a remote server, and wherein the preventing is performed by a local processing component integrated within the file system.

11. A system comprising:
a memory; and
at least one processor communicatively coupled to the memory, wherein the at least one processor is configured to:
retrieve a configuration file of a file system during boot of the file system;
apply configuration data from the configuration file to initialize a ransomware detection module;
detect an operation performed on a file stored in the file system;
apply a multi-layered ransomware detection process to the file that uses the ransomware detection module and content of the file; and
in response to a determination that the file includes ransomware, initiate a mitigation action to restrict further access to additional files in the file system.

12. The system of claim 11, wherein the at least one processor is configured to:
analyze a file format of the file to determine a deviation from a known structure;
analyze a filename of the file for ransomware-associated extensions,
inspect bit patterns in the file for indicators of encryption; and
examine content within a directory of the file to identify ransom-related artifacts.

13. The system of claim 11, wherein the at least one processor is configured to:
apply entropy analysis to the file or a portion of the file; and
execute a machine learning model that uses content extracted from a directory that contains the file to determine whether encryption characteristics consistent with ransomware are present.

14. The system of claim 11, wherein the at least one processor is configured to:
identify a plurality of files affected by ransomware;
generate a composite alert based on ransomware indicators associated with the plurality of files; and
transmit the composite alert to a display interface.

15. The system of claim 11, wherein the at least one processor is configured to:
extract contents from a directory that contains the file; and
execute a machine learning model that uses the contents to determine whether the directory includes a ransom note.

16. The system of claim 11, wherein the at least one processor is configured to initiate one or more mitigation actions comprising:
disable credentials associated with an initiating entity;
terminate a process linked to the operation;
restrict an IP address through a firewall;
restore a prior version of the file; and
transmit a notification to an administrator interface.

17. The system of claim 11, wherein the at least one processor is configured to identify a creation, access, update, or deletion operation associated with the file that uses a machine learning model trained on file activity patterns.

18. The system of claim 11, wherein the at least one processor is configured to update the configuration file of the ransomware detection module based on a correlation between observed ransomware indicators and outcomes recorded in a detection response log.

19. A computer-readable storage medium comprising program instructions stored thereon, the program instructions, when executed by at least one processor, causing the at least one processor to:
retrieve a configuration file of a file system during boot of the file system; apply configuration data from the configuration file to initialize a ransomware detection module;
detect an operation performed on a file stored in the file system;
apply a multi-layered ransomware detection process to the file using the ransomware detection module and content of the file; and
in response to determining that the file includes ransomware, initiate a mitigation action to restrict further access to additional files in the file system.

20. The computer-readable storage medium of claim 19, wherein the at least one processor is configured to:
analyze a file format of the file to determine a deviation from a known structure;
analyze a filename of the file for ransomware-associated extensions;
inspect bit patterns in the file for indicators of encryption; and
examine content within a directory of the file to identify ransom-related artifacts.
